(19) United States
(12) Patent Application Publication
(10) Pub. No.: US 2026/0256247 A1
(43) Pub. Date: Sep. 3, 2026

(54) SYSTEMS AND METHODS FOR PROTECTION OF SHOES AND USE THEREOF

(71) Applicant: SHINA CHEN, Irvine, CA (US)

(72) Inventor: SHINA CHEN, Irvine, CA (US)

(21) Appl. No.: 19/654,914

(22) Filed: Apr. 22, 2026

Related U.S. Application Data
(63) Continuation of application No. PCT/US25/34768, filed on Jun. 23, 2025.
(60) Provisional application No. 63/663,514, filed on Jun. 24, 2024.

(51) Int. Cl. A43C 13/08; A43B 1/14; A43B 9/14; A43D 95/28; C09J 5/00; C09J 7/25; C09J 7/29; C09J 7/38

(52) U.S. Cl. CPC A43C 13/08; A43B 1/14; A43B 9/14; A43D 95/28; C09J 5/00; C09J 7/25; C09J 7/29; C09J 7/385; C09J 2203/362; C09J 2301/162; C09J 2301/302; C09J 2301/304; C09J 2427/006; C09J 2433/00; C09J 2475/006

(57) ABSTRACT

A protective device includes a flexible, adherent sheet configured to surround and conform to an outer perimeter of a platform of a platform shoe having a heel located posteriorly of the platform, the sheet including an outer layer including a durable polymer and an inner layer including a pressure-sensitive adhesive

### INCORPORATION BY REFERENCE TO ANY PRIORITY APPLICATIONS

This application is a continuation of international application no. PCT/US2025/034768, filed on Jun. 23, 2025, which claims the benefit of priority to U.S. Provisional Application No. 63/663,514, filed on Jun. 24, 2024, both of which are incorporated by reference in their entirety herein for all purposes. Priority is claimed pursuant to 35 U.S.C. §120 and 35 U.S.C. § 119.

### BACKGROUND OF THE INVENTION

### Field of the Invention

The field of the invention generally relates to overshoes, including heel-less overshoes, of footwear, or more specifically the invention relates to a protection device for the toe box of platform shoes, including platform shoes for dancing, or more specifically pole dancing.

### SUMMARY OF THE INVENTION

In one embodiment of the present disclosure, a protective device includes a flexible, adherent sheet configured to surround and conform to an outer perimeter of a platform of a platform shoe having a heel located posteriorly of the platform, the sheet including an outer layer including a durable polymer and an inner layer including a pressure-sensitive adhesive.

In another embodiment of the present disclosure, a method for manufacturing a protective device configured to surround and conform to an outer perimeter of a platform of a platform shoe having a heel located posteriorly of the platform includes applying a pressure-sensitive adhesive to an inner surface of a film including a durable polymer, and cutting the adhesive-applied film into a sheet having a pre-cut shape.

In yet another embodiment of the present disclosure, a method for manufacturing a protective device configured to surround and conform to an outer perimeter of a platform of a platform shoe having a heel located posteriorly of the platform includes cutting a film including a durable polymer into a sheet having a pre-cut shape, and applying a pressure-sensitive adhesive to an inner surface of the sheet after the sheet has been cut.

In still another embodiment of the present disclosure a method for applying a protector onto a platform of a platform shoe includes wrapping a pre-cut sheet having a pre-applied adhesive on a first surface of the sheet around the platform, and applying internally oriented radial pressure to a second surface of the sheet such that the pre-applied adhesive adheres to an exterior of the platform.

### BRIEF DESCRIPTION OF THE DRAWINGS

FIG. 1 is a side perspective view of a pole dance platform shoe, according to an embodiment of the present disclosure.

FIG. 2 is a side perspective view of a pole dance platform shoe with a protector applied, according to an embodiment of the present disclosure.

FIG. 3 is a back perspective view of a pole dance platform shoe with a protector applied, according to an embodiment of the present disclosure.

FIG. 4 is a front perspective view of a pole dance platform shoe with a protector in the process of application, according to an embodiment of the present disclosure.

FIG. 5 is an elevation view of a right protector for a platform shoe, according to an embodiment of the present disclosure.

FIG. 6 is an elevation view of a left protector for a platform shoe, according to an embodiment of the present disclosure.

FIG. 7 is a side perspective view of a pole dance platform shoe with a protector applied, according to an embodiment of the present disclosure.

FIG. 8 is a back perspective view of a pole dance platform shoe with a protector applied, according to an embodiment of the present disclosure.

FIG. 9 is a front perspective view of a pole dance platform shoe with a protector in the process of application, according to an embodiment of the present disclosure.

FIG. 10 is an elevation view of a top layer of a right protector for a platform shoe, according to an embodiment of the present disclosure.

FIG. 11 is an elevation view of a top layer of a left protector for a platform shoe, according to an embodiment of the present disclosure.

FIG. 12 is an elevation view of a base layer and a protective layer of a protector for a platform shoe, according to an embodiment of the present disclosure.

FIG. 13 is a side perspective view of a pole dance platform shoe with a protector applied that has a plurality of layers, according to an embodiment of the present disclosure.

FIG. 14 is a back perspective view of a pole dance platform shoe with a protector applied that has a plurality of layers, according to an embodiment of the present disclosure.

FIG. 15 is a back perspective view of a pole dance platform shoe with a protector that has a plurality of layers, wherein the protector is in the process of application, according to an embodiment of the present disclosure.

FIG. 16 is a front perspective view of a pole dance platform shoe with a protector that has a plurality of layers, wherein the protector is in the process of application, according to an embodiment of the present disclosure.

FIG. 17 is an elevation view of a right protector for a platform shoe, according to an embodiment of the present disclosure.

FIG. 18 is an elevation view of a left protector for a platform shoe, according to an embodiment of the present disclosure.

FIG. 19 is an elevation view of a base layer of a right protector with relief cuts for a stiletto heel of a platform shoe, according to an embodiment of the present disclosure.

FIG. 20 is an elevation view of a base layer of a left protector with relief cuts for a stiletto heel of a platform shoe, according to an embodiment of the present disclosure.

FIG. 21 is an elevation view of a base layer for a protector for high arches, according to an embodiment of the present disclosure.

FIG. 22 is a side perspective view of a pole dance platform shoe with a protector applied that comprises three layers, according to an embodiment of the present disclosure.

FIG. 23 is a back perspective view of a pole dance platform shoe with a protector applied that comprises three layers, according to an embodiment of the present disclosure.

FIG. 24 is a back perspective view of a pole dance platform shoe with a protector that comprises three layers, wherein the protector is in the process of application, according to an embodiment of the present disclosure.

FIG. 25 is a front perspective view of a pole dance platform shoe with a protector that comprises three layers, wherein the protector is in the process of application, according to an embodiment of the present disclosure.

FIG. 26 is an elevation view of a right protector for a platform shoe, according to an embodiment of the present disclosure.

FIG. 27 is an elevation view of a left protector for a platform shoe, according to an embodiment of the present disclosure.

FIG. 28 is an elevation view of a base layer of a right protector with relief cuts for a stiletto heel of a platform shoe, according to an embodiment of the present disclosure.

FIG. 29 is an elevation view of a base layer of a left protector with relief cuts for a stiletto heel of a platform shoe, according to an embodiment of the present disclosure.

FIG. 30 is an elevation view of a base layer for a protector for high arches, according to an embodiment of the present disclosure.

FIG. 31 is a side view of a pole dance platform boot, according to an embodiment of the present disclosure.

FIG. 32 is a front view of a pole dance platform boot, according to an embodiment of the present disclosure.

FIG. 33 is a side view of a pole dance platform boot with a protector applied, according to an embodiment of the present disclosure.

FIG. 34 is a front view of a pole dance platform boot with a protector applied, according to an embodiment of the present disclosure.

FIG. 35 is an elevation view of right protector for a toe cap or toe box, according to an embodiment of the present disclosure.

FIG. 36 is an elevation view of left protector for a toe cap or toe box, according to an embodiment of the present disclosure.

FIG. 37 is an elevation view of an additional right protector for a toe cap or toe box, according to an embodiment of the present disclosure.

FIG. 38 is an elevation view of an additional left protector for a toe cap or toe box, according to an embodiment of the present disclosure.

### DETAILED DESCRIPTION OF THE ILLUSTRATED EMBODIMENTS

A pole dancing platform shoe is a specialized type of footwear designed primarily for use in pole dancing. These shoes commonly feature very high heels and thick platforms. Platform height can range from two inches to seven inches (50 mm to 178 mm). Heel or stiletto height can range from four inches to ten inches (101 mm to 254 mm), or six inches to ten inches (152 mm to 254 mm). These shoes not only enhance the aesthetic appeal of a pole dancing performance but also play a functional role in aiding the dancer's ability to perform certain moves and tricks on the pole. Poles used in pole dancing are commonly chrome, brass, steel, including stainless steel, circular cross-section poles that are 40 mm to 53 mm in diameter. In some cases, a silicone sleeve can be used on the pole to aid grip. In some cases, a power coat can be used.

Some key characteristics of pole dancing platform shoes include high heels, thick platforms, straps and ankle supports, and durable materials. The high heel is often stiletto style, thus providing significant height to the dancer. It is common for both the length and the width of the heel to taper down to reduced dimensions at the bottom of the platform, such that the contact surface with the ground or floor is reduced. The platform, which extends below the toe box of the shoe, located at the front of the shoe helps balance the height of the heel, making it easier for the wearer to walk and dance. Often, the platform extends from the toe box between a point at an extreme anterior end of the shoe and a point in a central location along the horizontal axis. It is common for both the length and the width of the platform to taper down to reduced dimensions at the bottom of the platform, such that the contact surface with the ground or floor is reduced.

Many of these shoes have straps for strapping the show to the foot of the dancer, to ensure the shoes stay securely on the feet during intricate movements. In some cases, the shoes are designed in the style of boots to provide additional support and to ensure the shoes stay securely on the feet during intricate movements. The shoes are often made from durable materials like PVC (polyvinyl chloride), leather, or patent leather (leather treated with a glossy polyurethane, acrylic, or other polymetric coating). The shoes can come in a variety of colors and designs, and often have a shiny or reflective finish to reflect light during performances, thus providing an augmented visual experience. Boot-style shoes can include material that extends from the ankle of the wearer, and up to mid-calf or even to the thigh.

Pole dancing platform shoes, given their specialized use and given the demands of pole dancing, often experience various types of wear and tear over time. Some common issues include:
1. Scuffed and scratched toe box and/or platform (uppers): The material on the surface of the platform/toe box area, whether made from leather, patent leather, PVC, or another material, can get scuffed or scratched from contact with the pole, floor, or other surfaces.
2. Worn Soles: The soles of the shoes can wear down, especially if the dancer frequently performs on abrasive surfaces or practices a lot.
3. Heel Damage: The heels, including stiletto heels, can become scratched, dented, or even loose due to the impact and pressure exerted during dancing and tricks.
4. Strap and Buckle Wear: The straps and buckles that secure the shoes can wear out or break, particularly with frequent use. Straps can stretch or snap, and buckles can become bent or detached.
5. Platform Separation: The thick platforms can sometimes begin to separate from the rest of the shoe, especially at the edges where the shoe flexes the most, and/or higher stresses are concentrated.
6. Flattening of Internal Cushion: The cushioning inside the shoe, that interfaces with the bottom of the foot, can compress and flatten over time, reducing comfort and support. This is especially common with frequent use and the high-impact nature of pole dancing.
7. Color Fading: The color or finish of the shoes can fade with exposure to light, sweat, and repeated cleaning. Aesthetically pleasing color and finish are important to performers.

Embodiments presented herein provide protection devices (protectors) for the platforms and toe box areas of platform shoes. The disclosed protection devices are durable, provide good translucency and clarity, and can be self-healing or restorable. The result effectively safeguards the dancer's shoes while maintaining their aesthetic appeal.

The present disclosure relates to the protection of the platform/toe box area of pole dance platform shoes and boots. The embodiments presented herein avoid the addition of excess bulk to the shoes, thus maintaining their comfort, fit, and feel, and also adding very little to their overall weight. The protectors of the present disclosure do not slip, thus avoiding interference with the successful performance of a dance presentation. The protectors disclosed herein do not significantly reduce the dancer's tactile feedback from the shoes, thus avoiding negative effects to the precision in foot placement and movement. The protectors do not need to be cleaned regularly, thus avoiding the addition of significant maintenance requirements. The protectors disclosed in the present embodiments to not detract from the sleek or stylish appearance of the shoes or boots, and can thus maintain a high level of aesthetics.

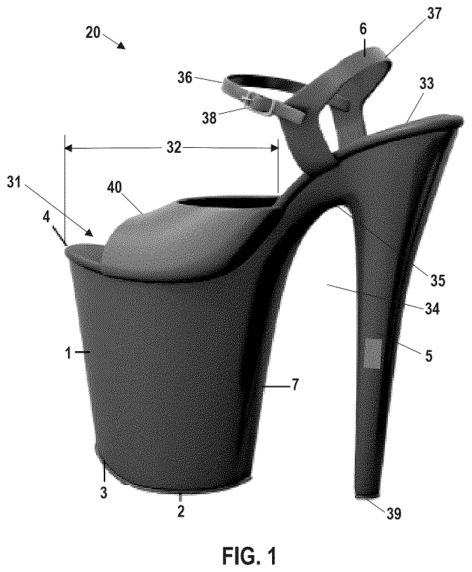

FIG. 1 illustrates the basic anatomy of a pole dance platform shoe 20. The toe 4 can be open or closed. Open-toe designs, having an opening 31, tend to allow for more flexibility in terms of foot/shoe fit, and have more breathability, while closed-toe designs can offer more protection of the foot. Whether the design is open-toe or closed-toe, the toe box area 32 includes a cover area 40 that either extends partially longitudinally along the toe box area 32 or completely along it. The platform 1, or dance platform, extending inferiorly from the toe box area 32, is the tapering mass between the angled outsole 3 and the toe 4. The angled outsole 3 and sole 2 are commonly made from rubber, thermoplastic elastomer, or another non-slip material to provide good traction and to withstand the rigors of dancing, including spins, slides, and other movements. The angled outsole 3 often forms an obtuse angle with the sole 2, as shown in FIG. 1. The heel 5 includes a top piece 39, also known as a heel tip, heel cap, or top lift. It can also be made from rubber, thermoplastic elastomer, or another non-slip material. The heel 5, often called the stiletto when it has significant length and/or thinness, is designed to be very high, ranging from 5 to 12 inches (12.7 cm to 30.5 cm) or even more. The heel height is an important characteristic for aesthetics and for the functionality of the shoe. The platform 1 often has a height that is significant, but is less than the heel height, because of the upward curvature of the curved insole 33 that places the heel of the foot at a higher elevation than the toes. Between the platform 1 and the heel 5 is an open space 34. The platform 1 and the heel 5 each taper inwardly toward an arch 35. The shape of the open space 34. And the tapering of both the platform 1 and the heel 5 (e.g. changes in width and/or length along a vertical axis) are also important aesthetic characteristics. The open space 34 can also have important performance characteristics in certain dance moves in which the open space 34, and more particularly the arch 35, can engage with the pole. Smooth transitions between the surfaces of the platform 1, arch 35, and heel 5 can serve to facilitate moves of the arch 35 against the pole, contacting it, engaging it, sliding longitudinally along it, and disengaging from it.

The straps 6 can broadly include front ankle straps 36, back ankle straps 37 buckles 38, or alternatively, lace-up features, to ensure the shoes stay securely attached to the feet during complex maneuvers. The back 7 of the platform 1, also referred to as the shank, and is commonly reinforced to provide stability to a person's heel and ankle, to prevent its wobbling. The reinforcement can comprise composite structures having support members (not shown) internally or externally.

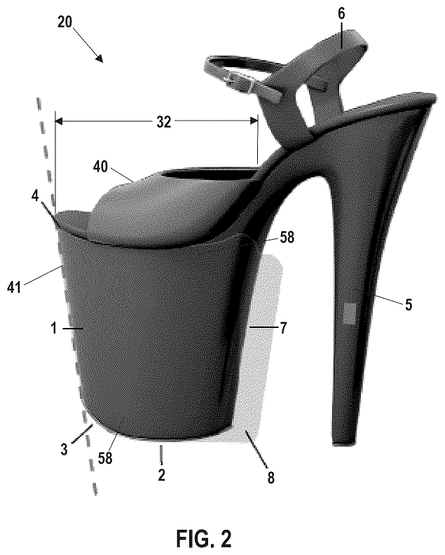

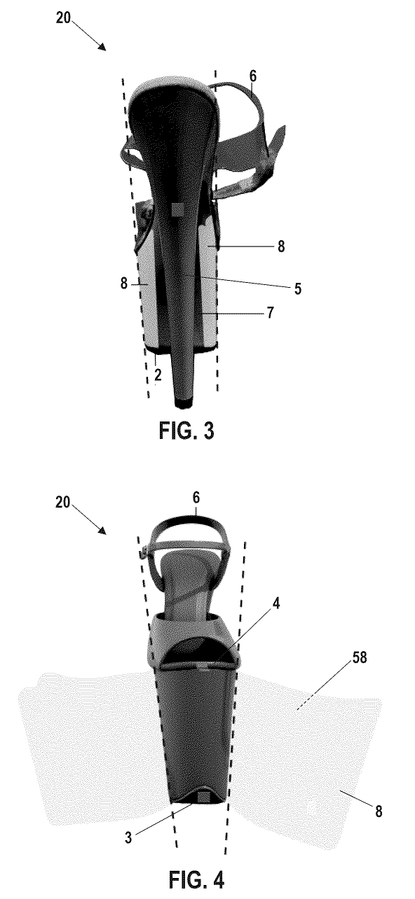

The present disclosure provides clear precut protective sheets 8, 9 comprising films that are configured to protect the platform 1 and/or toe box area 32 of pole dancing platform shoes 20. The protective sheet 8, 9 wraps around the platform 1 including the front 41 of the platform 1 and the back 7 of the platform 1, and all of the continuous circumferentially extending surface that defines the exterior around the platform 1. As shown in FIGS. 2, 3 and 4, the sheet 8 comprises a clear protective film that has great clarity, and can be virtually invisible, thus being substantially non-impeding of the shoe's color, design patterns, and overall visual appeal. The outer surface of the sheet 8, 9 can be provided with a gloss finish.

The sheet 8, 9 can also be configured to provide self-healing properties to maintain a substantially pristine appearance. The protective properties of the sheet 8, 9 prolongs the life of the shoe 20 by safeguarding against wear and tear. The material and texture of the sheet 8, 9 can also be varied to enhance traction and durability. The sheet 8, 9 can include a single film or one or more layer comprising a polymer such as thermoplastic polyurethane (TPU) but can also or alternatively include, but not be limited to: thermoplastic elastomer (TPE) such as thermoplastic vulcanizate (TPZ), thermoplastic polyamide (TPA), and silicone elastomers, each of which can be adjusted to have a range of properties, including properties similar to TPU, such as flexibility, durability, and resistance to various environmental factors. The sheet 8, 9 can be configured to be permanently attachable or removable (removably attachable). The sheet 8, 9 is flexible to further provide a close, or substantially perfect fit without compromising the aesthetics or performance of the shoe 20.

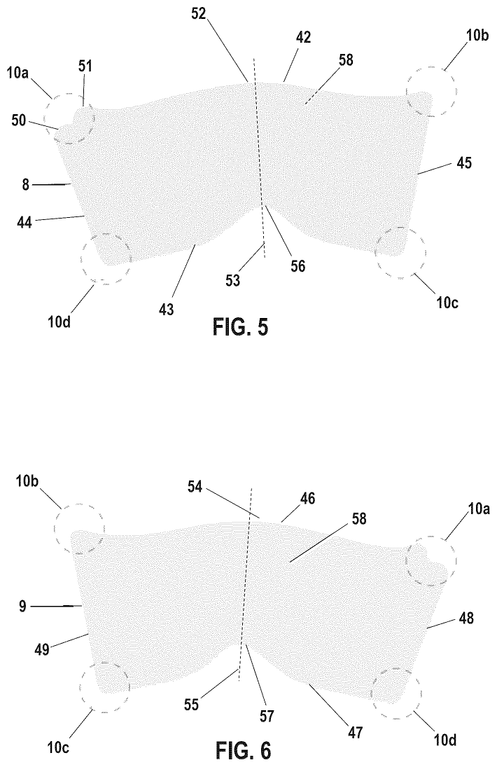

FIGS. 5 and 6 illustrate two versions of precut protective films that comprise the sheets 8, 9: one film 8 is pre-cut for the right shoe 20 and one film 9 is pre-cut for the left shoe 20. The right sheet 8 includes an upper side 42, a lower side 43, a first lateral side 44 and a second lateral side 45. The left sheet 9 includes an upper side 46, a lower side 47, a first lateral side 48 and a second lateral side 49. Corners 10 join the sides. Corner 10a is between sides 42 and 44 in sheet 8 and between sides 46 and 48 in sheet 9. Corner 10b is between sides 42 and 45 in sheet 8 and between sides 46 and 48 in sheet 9. Corner 10c is between sides 43 and 45 in sheet 8 and between sides 47 and 49 in sheet 9. Corner 10d is between sides 43 and 44 in sheet 8 and between sides 47 and 48 in sheet 9. The corners 10 are shaped to prevent lifting from the forces of dancing and the friction on the film from surfaces that it may contact. The corners 10 have no sharp points that could get caught or hook into an object. The corners 10 also help to apply and remove the protective film 8,9 from the platform 1, without inflicting any pain onto the user. The corners 10a-d comprise fillets. The corners 10b, 10c, 10d comprise single fillets having a radius of curvature of between 2 mm and 20 mm. The corners 10 a comprise double fillets, each having a radius of curvature of between 2 mm and 20 mm. In some embodiments, single-fillet corner 10b is configured to be lain between first sub-fillet 50 and second sub-fillet 51 when the sheet 8 is wrapped around the platform 1 and secured to the platform 1 (e.g., via an inner adhesive layer). Sheet 8 is a mirror image of sheet 9. In alternative embodiments, identical sheets can be used on each platform 1. However, shoes 20 can often have asymmetric platforms 1 that are mirror images of each other, and that may be best covered by appropriately-shaped left and right sheets 8, 9.

The upper side 42 of the sheet 8 comprises a central convexity 52 that is arranged along a centerline 53 that passes through a midpoint of the upper side 42. The upper side 46 of the sheet 9 comprises a central convexity 54 that is arranged along a centerline 55 that passes through a midpoint of the upper side 46. The centerlines 53, 55 pass through an upper extreme dimension of the sheets 8, 9, but do not pass through lower extreme dimensions. However, this is not a requirement, as platforms 1 can have a variety of configurations thus recommending appropriate pre-cut shapes of the sheets. The lower side 43 of the sheet 8 comprises a central cavity 56 that is arranged along the centerline 53. The lower side 47 of the sheet 9 comprises a central convexity 57 that is arranged along the centerline 55. The upper sides 42, 46 and the lower sides 43, 47 have curvilinear contours. In other embodiments, one or more of them can comprise substantially straight lines. The lateral sides 44, 45, 48, 49 comprise substantially straight lines. In alternative embodiments, one or more of them can comprise curvilinear contours. The lateral sides 44, 45, 48, 49 are each adjacent to one of the upper sides 42, 46 and adjacent to one of the lower sides 43, 47. The lateral sides 44, 45 of the sheet 8 are not parallel to each other, but are angled such that the sheet 8 is wider at an upper portion and narrower at a lower portion. The lateral sides 48, 49 of the sheet 9 are not parallel to each other, but are angled such that the sheet 9 is wider at an upper portion and narrower at a lower portion. This can be appropriate for evenly and efficiently covering platforms 1 that taper down to a smaller lengths and widths at the bottom, where the platform interfaces with the ground or floor (e.g., via the sole 2). The sheets 8, 9 can be sized in relation to the target platforms 1, such that there is virtually no overlap, or minimal overlap. In other embodiments, a certain amount of overlap can be designed in. For example, an overlap of between about 1 mm to about 30 mm.

The protective films 8, 9 are attached by an adhesive, either applied during installation onto the shoe 20 during construction of the shoe 20, or configured pre-applied to the film 8, 9 by the user or during manufacturing of the sheet 8, 9. A pre-applied adhesive can be chosen from a family of adhesives called polyacrylate pressure-sensitive adhesives (PSA). Polyacrylate pressure-sensitive adhesives are chosen for their excellent performance characteristics, which include: strong adhesion, clarity, UV Resistance, chemical resistance, temperature (high and low) tolerance, repositionability, and removability. These attributes make polyacrylate pressure-sensitive adhesives effective for adhering to the protective film 8, 9 and attaching to and being removable from the platforms 1 of pole dancing platform shoes 20. In alternative embodiments, the pressure-sensitive adhesives (PSA) can comprise silicone.

In a particular embodiment, the Pole Dancing Platform/Toe box Protectors 8, 9 (e.g., sheets) comprise a pre-cut, thin, flexible layer of TPU film with a PSA self-adhesive that can be applied to the platform 1 of pole dance platform shoes 20 by wrapping it therearound and securing it via inward radial pressure. Material Composition: The film protectors 8,9 are fabricated from thermoplastic polyurethane (TPU). It is a class of polyurethane plastics known for its elasticity, transparency, and resistance to oil, grease, and abrasion. TPU is a versatile material that combines the properties of both rubber and plastic, making it suitable for a wide range of applications. In some embodiments, aliphatic polyurethane is utilized. TPU is renowned for its clarity, durability, and self-healing properties and the thickness of the sheet 8, 9 can range between 0.25 mm and 3.0 mm thick, or between 0.6 mm and 1.0 mm thick, which can allow it to remain inconspicuous while also providing robust protection. Design and Appearance: the TPU film protector 8, 9 is substantially clear, making it virtually invisible when applied to the platform 1, thus maintaining the original aesthetic of the shoe 20. The sheets/protectors 8, 9 can have a smooth finish, which enhances the dancer's ability to perform by reducing friction and allowing for smoother movements. The protectors 8, 9 can also have rounded corners 10 to aid in the planned application and removal of the film, but to also prevent unwanted removal while dancing and contacting the floor or other surfaces. Durability and Performance: The TPU film protectors 8, 9 are configured to resist scratching, scuffs, and abrasions, effectively protecting the platform 1 and toe box area 32 from damage. The protective film 8, 9 TPU material can withstand high temperatures, ensuring durability even in demanding conditions. Utilizing advanced polymer technology, the protective films 8, 9 can self-heal minor scratches and scuffs when exposed to heat, maintaining a pristine appearance over time. Application and Use: The film protectors 8, 9 are designed for easy application, conforming to the contours of the platform 1 and toe box 32 without the need for specialized tools. The adhesive 58 (FIGS. 2 and 4) allows for secure attachment without leaving residue when removed, enabling periodic replacement as needed. Restorative Properties: In addition to protection, the TPU film can restore and enhance the shine of paint on the shoe 20, keeping the footwear looking new.

In one embodiment, the sheets 8, 9 are protective films with an adhesive layer added, as described. The steps to apply the pre-cut sheets 8, 9 to the platform 1 are as follows:
1. Clean and prep the surface of the platform 1 and film 8, 9 with rubbing alcohol.
2. Spray soapy water to the adhesive (e.g., inner) side of the protective films 8, 9 and the platform 1 of the shoe 20.
3. Apply the sheet 8, 9 to the platform 1 area of the shoe 20, with the adhesive 58 side in, starting from the front with a midline of the sheet 8, 9 and wrapping around both sides to the back 7 of the platform 1.
4. Squeegee the sheet 8, 9 to squeeze out air bubbles and ensure a smooth, tight fit.
5. Using low heat source, such as a hair dryer on low heat, activate the adhesive 58 and adhere the protective sheet 8, 9 to the shoe 20.
6. Allow 24 hours to substantially dry.

If scuffs, cuts or other damage happen to the protective sheets 8, 9, applying low heat again can allow the protective sheets 8, 9 to self heal and look new and substantially clear again. The end result will depend on the initial extent of the damage to the protective sheets 8, 9. This reclarifying feature enables the protectors 8, 9 to maintain a clear, glossy appearance over multiple uses, and it extends the aesthetic life of the protector 8, 9, particularly in performance or competition settings.

As an alternative to the film protectors 8, 9 being clear, a particular design can be pre-applied to the film protectors 8, 9 to change the aesthetics of the shoe 20. The film protectors 8, 9 can have top extensions to be applied on the cover area 40 of the shoe 20 for open-toe shoes 20 as well for closed-toe shoes 20. The top extensions can have cuts or slits to allow the material to fold over the toe with little to no overlap and bunching or wrinkling.

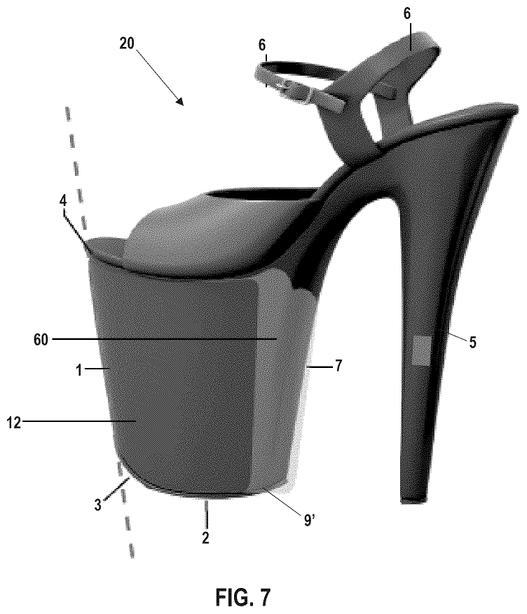

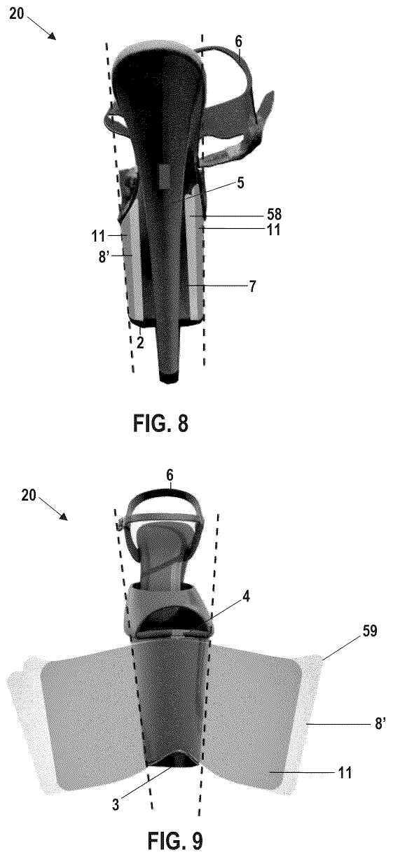

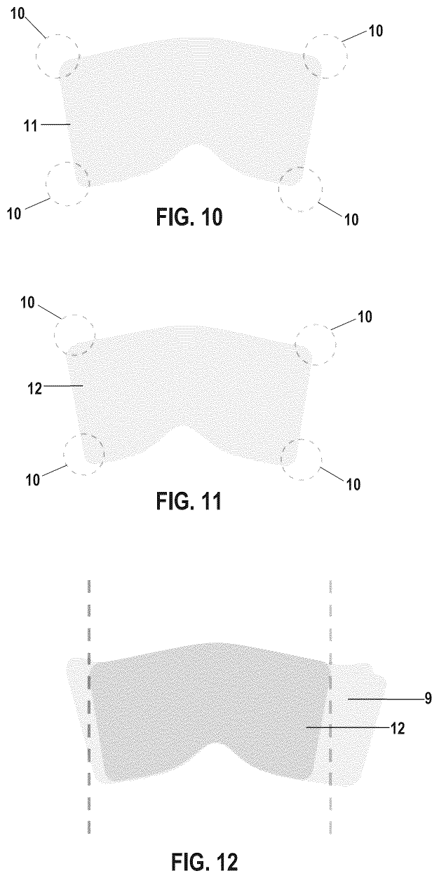

FIGS. 7 to 9 show an alternative embodiment, where the sheets 8′, 9′ comprise two layers of protective films with each layer having different properties to further enhance the durability, scratch resistance, and aesthetic preservation over a single layer film. In this particular embodiment, the two layer protective film system has only the two distinct laminate layers, and not a third laminate layer (the adhesive layer is still applied but this is not considered a laminate layer). The bottom (inner) layer precut film protector 59, 60 comprises a thermoplastic polyurethane (TPU), a polymer known for its elasticity, transparency, and resistance to oil, grease, and abrasion. This layer provides the primary protective function by covering the platform 1 of the shoe and protecting it from scratches, scuffs, and abrasions. The adhesive 58 is applied onto the inner surface of the inner layer 59, 60. Additionally, patterns and colors can be printed directly onto this TPU layer 59, 60, allowing for customization of the shoe's appearance, such as adding vibrant colors or intricate designs. As with the single layer film protectors 8, 9, a PSA 58 can be used to adhere the bottom layer to the platform 1. The bottom layer films 59, 60 range in thickness from . 05 mm to 0.80 mm, depending on the desired level of protection. The bottom layer films 59, 60 are also designed to be removable without leaving residue, allowing for periodic replacement as needed. A top (outer) layer precut protective films 11, 12, as shown in FIGS. 10-12 are made from polyethylene terephthalate (PET) film, a strong and durable material commonly used in window safety films. PET is known for its high tensile strength, flexibility, optical clarity, and resistance to environmental factors such as heat and UV exposure. In alternative embodiments, other polyesters, such as PETG are instead used. The top (outer layer) 11, 12 can have a thickness of 0.05 mm to 3.00 mm, or 0.25 mm to 1.00 mm. The total thickness of the two-layer protective film system ranges from 0.10 mm to 0.80 mm, or 0.15 mm to 0.4 mm, to provide a balance between protection and maintaining the shoe's aesthetic appearance.

Alternative materials for the top layer can include polycarbonate (PC) film, polyvinyl chloride (PVC) film, or polyimide (PI) film, which offer similar properties in terms of strength, clarity, and environmental resistance. The top layer is coated with a scratch-resistant coating to provide additional protection and improve durability. The top layer is slightly narrower in width than the bottom layer to prevent lifting at the edges during use. Thus, the handling of the sheets 8′, 9′ can be primarily done by manipulating the edges of the inner layer 59, 60. The outer layer 11, 12 enhances the overall strength and longevity of the protective film system.

The steps to apply the protective film system to the platform 1 of pole dancing platform shoes 20 are as follows:
1. Preparation: Clean and prep the surface of the platform 1 with rubbing alcohol to remove any dirt, oils, or residue.
2. Adhesive Activation: Spray a solution of soapy water onto the adhesive 58 side of the bottom layer 59, 60 and the surface of the platform 1.
3. Film Application: Apply the bottom layer 59, 60 to the platform 1 from the front with a midline of the sheet 8′, 9′, and wrap around both sides to the back 7 (shank) of the platform 1 of the shoe 20. Use a squeegee to remove air bubbles and ensure a smooth fit.
4. Lamination: Once the bottom layer 59, 60 is securely in place, apply the top layer 11, 12 of PET film (or an alternative material), ensuring that the narrower width aligns properly with the bottom layer 59, 60.
5. Heat Activation: Use a low heat source, such as a hair dryer, to activate the adhesive and ensure a secure bond between the layers 59, 60, 11, 12 and the platform 1.
6. Drying Time: Allow 24 hours for the film to dry and fully adhere to the shoe.

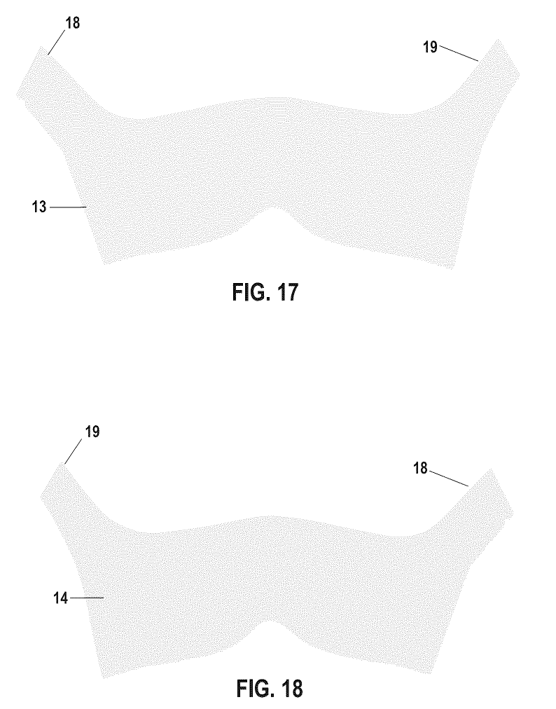

FIGS. 17 and 18 illustrate alternative pre-cut base layers 13, 14 with extensions 18, 19 for the arch that could be used in one-, two-or three-layer applications. FIG. 17 for the right shoe 20 and FIG. 18 is for the left shoe. Base layers 13, 14 can be made from the same materials and utilize the same adhesives as base layers 8,9 and be applied to the shoe 20 in the same manner. Each extension 18, 19 extends in a peninsula-like manner upwardly and outwardly.

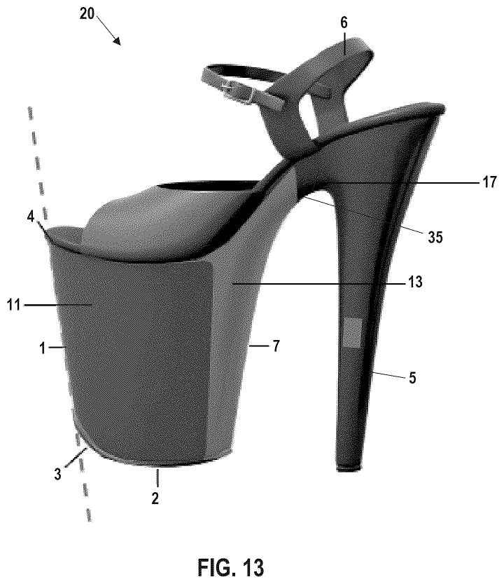

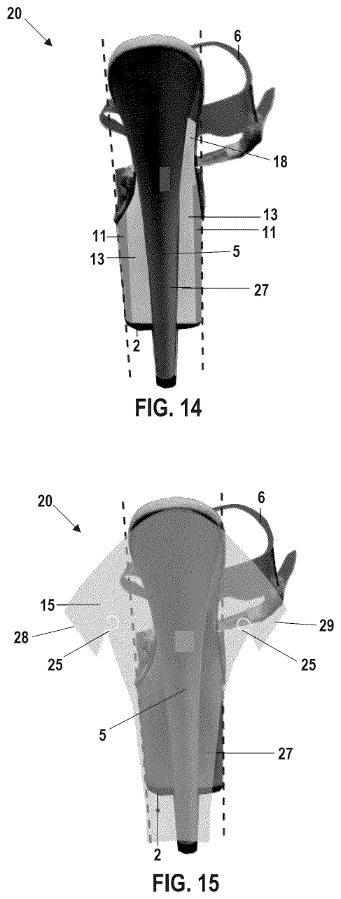

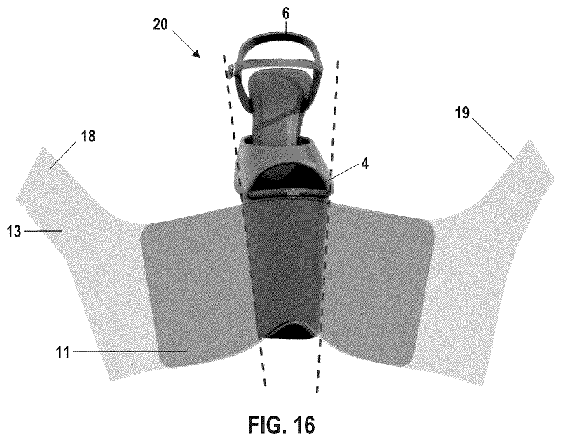

FIGS. 13, 14 and 16 illustrate base layer 13 being used in a two-layer application. FIG. 13, is the side view of both layers 11 and 13 being applied to the front of the platform 1, and around the toe box 32 of shoe 20 with the extension 19 covering more of the arch 35 between the platform 1 and the heel 5. FIG. 14 is the rear view of the completed application of both protective layers 11 and 13 being applied to the shoe with layer 13 covering more of the arch 35. FIG. 16 is a front view of both layers 11 and 13 being applied to the platform 1. While FIG. 16 shows both layers being applied at the same time, in other embodiments layers are applied one at a time. However, layers can be supplied pre-applied together so that a user can apply both layers at the same time to minimize the number of steps for application.

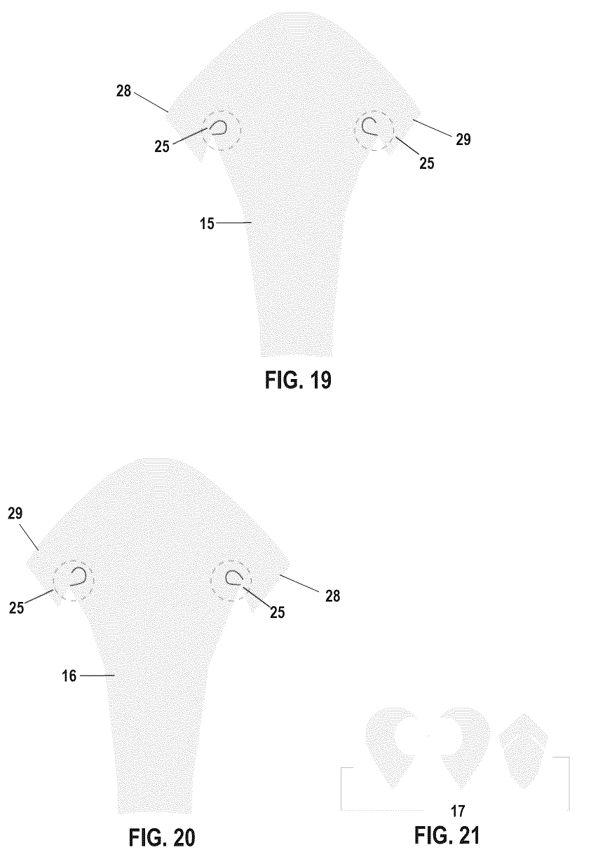

FIGS. 19 and 20 illustrate pre-cut base layers 15, 16 of a protective film for the heel/stiletto 5 of a shoe 20. The base layers 15, 16 can be made from the same materials and utilize the same adhesives as the base layers 8, 9 and can be applied to the shoe 20 in the same manner. Relief cuts 25 can be made on the layers 15, 16 to add the ability of adjacent wings 28, 29 to flex outwardly or inwardly as needed, such that when applied, they will not fold and/or bunch up as the layer 15, 16 is formed around the curved and tapered heel/stiletto 5.

FIG. 15 shows the application of the base layers 15, 16 to the heel/stiletto 5 of a shoe 20, including the sides and back of the heel shaft 27 and extending into the arch 35 area to promote full or substantially full visual and/or protective coverage.

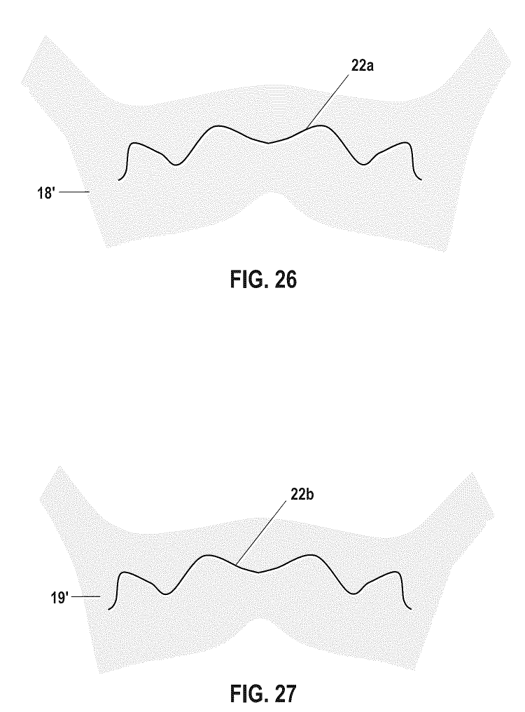

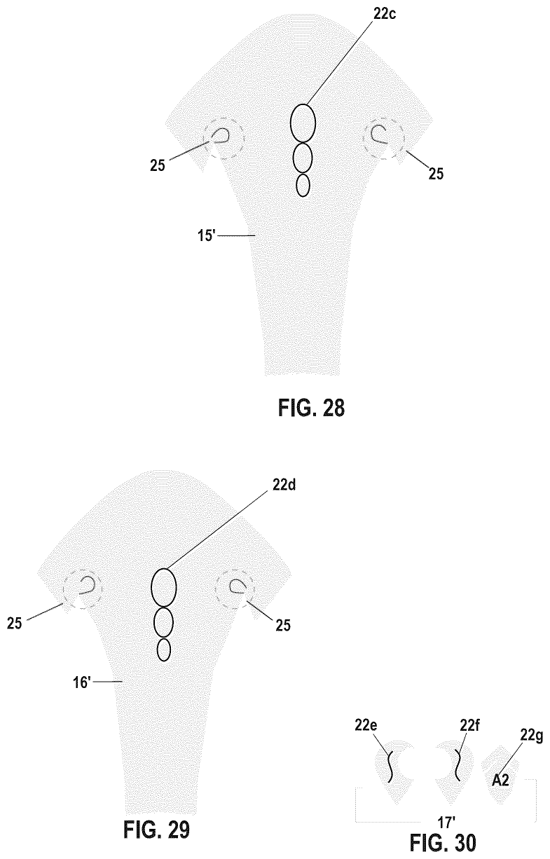

FIGS. 26-30 illustrate alternative embodiments 13′, 14′, 15′, 16′, 17′ of layers 13, 14, 15, 16, and cutouts 17, respectively, comprising printed designs or text 22a-g.

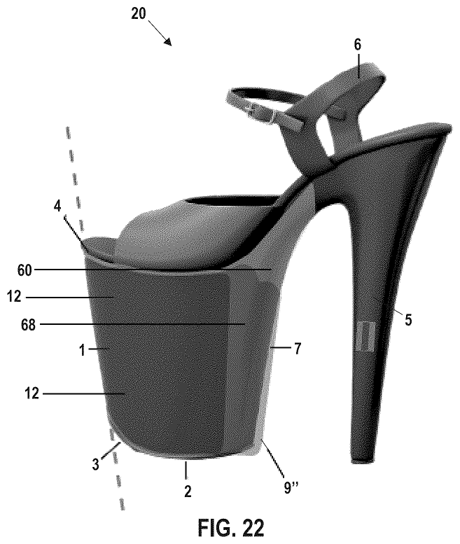

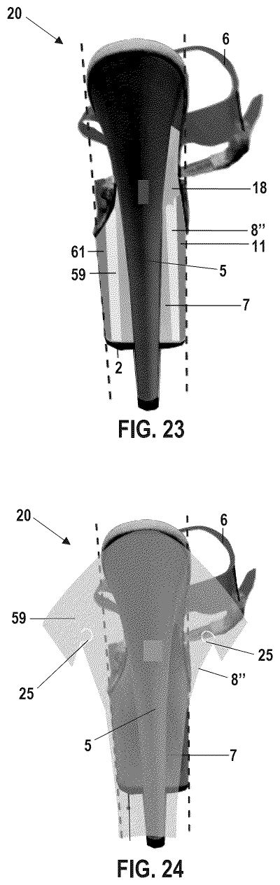

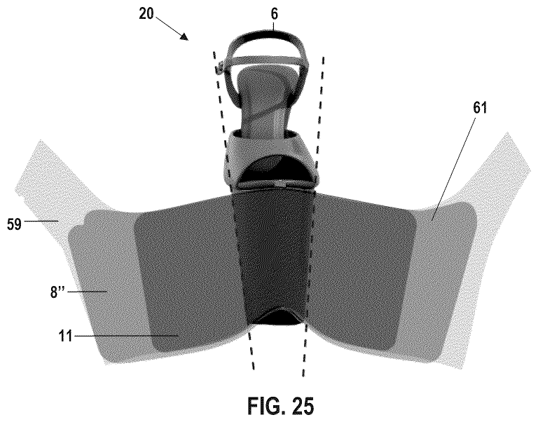

FIGS. 22-25 show still yet another embodiment, a three-layer precut protective film system 8″, 9″ designed to protect and customize the platform 1 of pole dancing platform shoes 20. This system 8″, 9″ augments that performance of protective sheets 8′ ,9′ by enhancing durability, customization options, and aesthetics. The multi-layer film system 8″, 9″ comprises three distinct layers: Bottom Layer 59, 60 (Base Film): The bottom layer is made from thermoplastic polyurethane (TPU), a polymer known for its elasticity, transparency, and resistance to oil, grease, and abrasion. This layer provides the primary protective function by covering the platform 1 of the shoe 20 and protecting it from scratches, scuffs, and abrasions. Additionally, the TPU layer 59, 60 prevents the adhesive 58, from the middle vinyl layer 61, 62 from leaving residue on the shoe's surface. As with the single layer film protector 8, 9, a PSA 58 can be used to adhere the bottom layer 59, 60 to the platform 1. The bottom layer 59, 60 ranges in thickness from 0.05 mm to 0.80, depending on the desired level of protection. Middle Layer 61, 62 is made from polyvinyl chloride (PVC): The middle layer 61, 62 is a customizable PVC film designed to allow users to change the color or pattern of the shoe's platform. This layer can feature a wide variety of designs, including solid colors, holographic finishes, or printed patterns. The middle layer can range from 0.05 mm to 0.20 mm in thickness. The PVC layer 61, 62 adheres securely to the bottom TPU layer 59, 60, and its removability allows for easy customization without damaging the shoe 20. Top Layer (Protective Film) 11, 12: The top layer is made from polyethylene terephthalate (PET) film, a strong and durable material commonly used in window safety films. PET is known for its high tensile strength, flexibility, optical clarity, and resistance to environmental factors such as heat and UV exposure. The top layer 11, 12 can be coated with a scratch-resistant coating to provide additional protection and improve durability. This layer 11, 12 enhances the overall strength and longevity of the multi-layer system while preserving the aesthetic appeal of the vinyl layer 61, 62 beneath. The top layer 11, 12 can range in thickness from 0.05 mm to 0.15 mm. Specialized pressure-sensitive adhesives 58 are used between the TPU and PVC layers, as well as between the PVC and PET layers, ensuring secure bonding while allowing for removability when needed. The total thickness of the three-layer film system 8″, 9″ ranges from 0.15 mm to 1.15 mm, or from 0.25 mm to 0.5 mm, to ensure a balance between protection, customization, and maintaining the shoe's 20 aesthetic appearance. The result is a thin, low-profile system that maintains the original form and feel of the platform shoe 20. It can be noted that the first 2 layers could be interchanged where the first layer is the customizable PVC film and the middle layer a clear TPU layer.

The steps to apply the multi-layer protective and customizable film system to the platform 1 of pole dancing platform shoes 20 are as follows:
1. Preparation: Clean and prep the surface of the platform 1 with rubbing alcohol to remove any dirt, oils, or residue.
2. Bottom Layer Application: Apply the TPU bottom layer 59, 60 to the platform 1 from the front with a midline of the sheet 8″, 9″, and wrap around both sides to the back 7 of the platform 1 of the shoe 20. Use a squeegee to remove air bubbles and ensure a smooth fit.
3. Middle Layer Application: Apply the PVC layer 61, 62 to the TPU layer 59, 60, ensuring alignment and smooth adhesion. Trim any excess material if necessary.
4. Top Layer Application: Apply the PET top layer 11, 12 over the PVC layer 61, 62, ensuring that the narrower width aligns properly with the underlying layers, 61, 62, 59, 60. Use a squeegee to remove air bubbles and ensure a smooth fit.
5. Heat Activation: Use a low heat source, such as a hair dryer, to activate the adhesives 58 and ensure a secure bond between all layers, 11, 12, 61, 62, 59, 60.
6. Drying Time: Allow 24 hours for the film system to dry and fully adhere to the shoe.

The pressure-sensitive adhesive 58 in some embodiments is sprayed onto any one of the film layers. The pressure-sensitive adhesive 58 in some embodiments is painted onto any one of the film layers. The pressure-sensitive adhesive 58 in some embodiments is applied onto any one of the film layers by a dipping process.

Multi-layer sheets comprise a layer having a plurality of sub-layers. In some embodiments, an inner sub-layer comprises any of the inner layer materials described herein, including but not limited to TPU, or PET, and has a thickness of 0.05 mm to 0.80 mm. In some embodiments, a middle sub-layer comprises any of the inner layer materials described herein, including but not limited to PVC, and has a thickness of 0.15 mm to 1.15 mm.

The pre-cut protectors/protective sheets 8, 9, 8′, 9′, 8″, 9″ and the teardrop-shaped cutouts 17, 17′, and the protectors 23, 24 can in some embodiments be cut by a laser cutting process, or a by die and punch processes.

The multi-layer protective system is engineered to preserve the natural feel and performance characteristics of pole dancing platform shoes. The outermost layer, 11, 12, made from PET film, features a finish that closely mimics the gloss and texture of the original shoe surface. Additionally, the base TPU layer 59, 60 is optionally coated with a nano-ceramic finish, which further replicates the original tactile properties of patent leather or PVC used in the footwear. For example, when felt through a substantially thin covering layer.

As a result, when the full system is applied, dancers experience no noticeable difference in grip, movement, or control on the pole. Unlike traditional silicone or fabric covers, which can introduce friction or slippage, the present invention is engineered for seamless integration with the shoe, ensuring dancers retain full confidence in their footwork, slides, spins, and climbs. Additionally, when an affected film layer finally requires replacement, it can be done individually without removing the entire system. This is particularly relevant in the two and three layer system configuration where the PET top layer is modular and replaceable, allowing dancers to maintain a clean, polished appearance without rewrapping or replacing the entire setup.

The outer layers, such as the PET and TPU films, feature smooth surfaces that in many cases can improve gliding and sliding motions during floorwork, exotic basework, or transitions. This controlled reduction in surface friction enhances fluidity and flow-based choreography. The layered structure ensures consistent balance, grip, and control, especially important during precision-dependent tricks, pivots, spins, and slides, where the feel and behavior of the shoe surface can affect execution.

In each of the embodiments presented herein, any one of the layers, or in multiple layer sheets, the combined composite sheet, can comprise a refractive index of less than 1.65, or less than 1.55, or between 1.35 and 1.64, or between 1.45 and 1.64. The sheet has sufficient clarity to view detail of an exterior of the platform 1 when the sheet is wrapped closely therearound in standard lighting. This includes the securing layers of pressure-sensitive adhesive.

FIGS. 21 and 30 are teardrop-shaped cutouts 17, 17′ are that can cover and close small exposed sections, particularly around high-stretch zones or complex curves. These finishing elements ensure a cohesive, seamless wrap appearance across the full surface of the shoe.

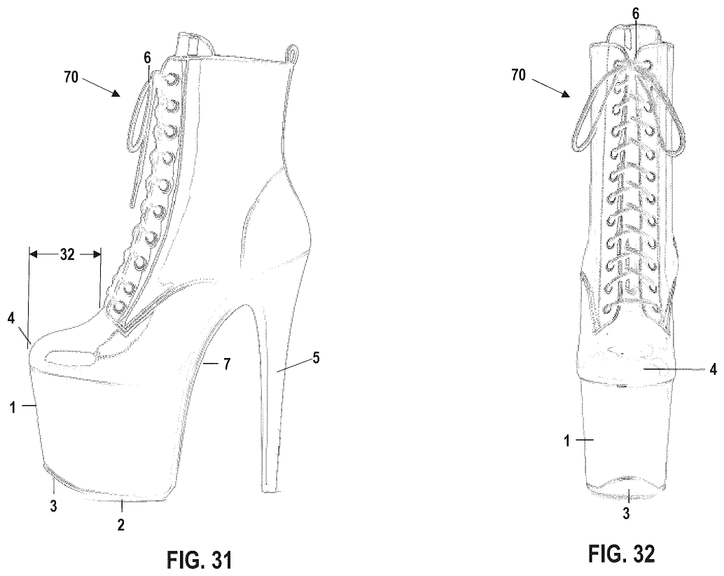

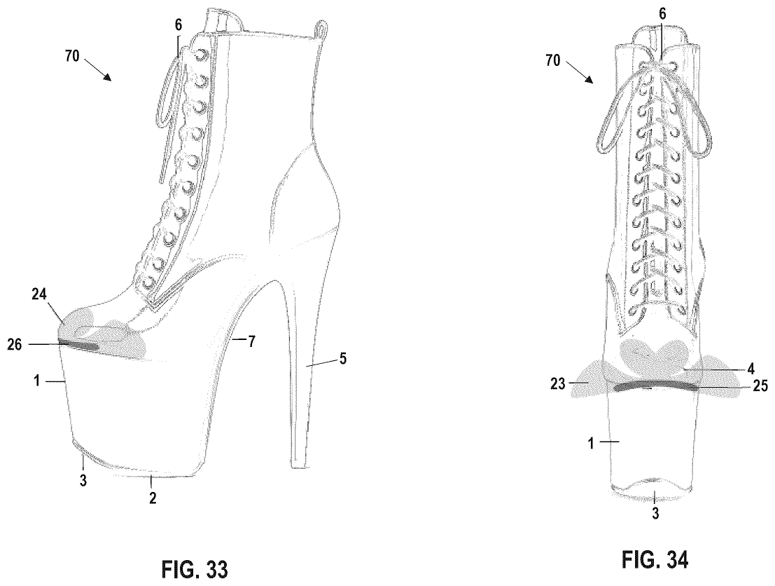

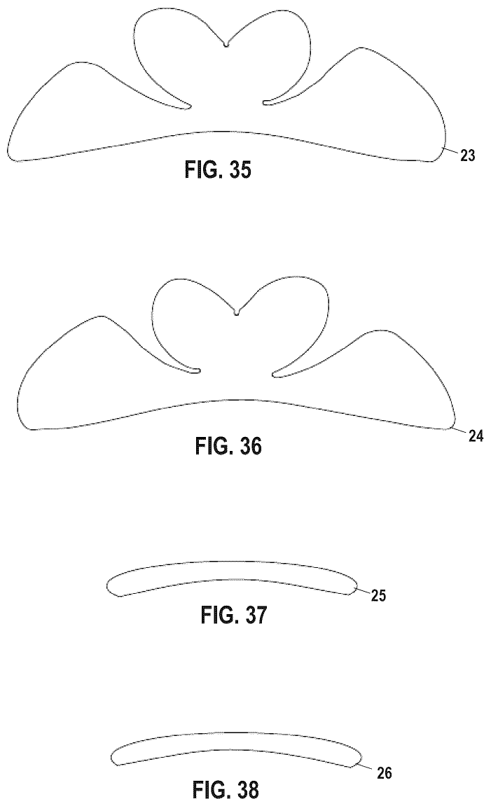

FIGS. 31 and 32 illustrate a closed-toe platform boot 70, such as those used in pole dancing and performance art. These boots 70 are subject to significant abrasion and impact at the toe tip area 4 of the toe box area 32 during floor work, toe drags, and bodyweight transfers. In this embodiment, the hybrid protective toe film 23, 24 as shown in FIGS. 35 and 36, are for closed-toe platform footwear comprising a precisely contoured shape designed to shield the toe tip 4 and adjacent or surrounding curved surfaces. The protector 23, 24 is made from a flexible thermoplastic polyurethane (TPU) base layer and reinforced with a top coating of transparent flexible resin, forming a clear, durable barrier against abrasion and scuffing, particularly during high-impact use such as pole dancing. The protector 23, 24 for these boots comprises a pre-cut protective film 23, 24 made of flexible, optically clear material such as thermoplastic polyurethane (TPU), paint protection film (PPF), or resin-based composite. The protective film 23, 24 is shaped in a “bat wing with bat head” configuration as shown in FIGS. 33-36, which conforms to the three-dimensional curves at the top of the front toe box area 32 of the boot. Application methods can include heat-molding the TPU base around the shoe contour, manual alignment and adhesive pressure bonding similar to precut protective films 8, 9. A top coating of flexible transparent resin 25, 26 (FIGS. 33-34 and 37-38), applied over a portion of the protective film 23, 24, increases the abrasion resistance and prolongs the life of the toe protector 23, 24. This resin can comprise a UV-cured or epoxy-based material with flexible properties (Shore hardness ranging between 60A-90A). The resin coating 25, 26 is permanently bonded to the TPU surface of the protector 23, 24 using one or more of the following methods: 1) Direct application via pouring or brushing, followed by UV curing, or 2) sun drying heat-assisted adhesion following light surface abrasion or use of a chemical primer. The combined structure results in a thin, nearly invisible protective layer with base adhesion and flexibility from TPU layer 23, 24 and scratch and scuff resistance from resin outer layer 25, 26. In alternative embodiments, a PET layer can be placed over the resin coating 25, 26 prior to curing of the resin coating 23, 24. In alternative embodiments, the PET layer can be placed within the resin coating 23, 24 prior to curing of the resin coating. The additional PET layer helps to resist friction (e.g., floor friction) to minimize wearing of the TPU layer 23, 24 and/or the resin layer 25, 26.

The height of any of the protectors for platforms 1 presented herein can range from two inches to seven inches (50 mm to 178 mm). The height of any of the protectors for heels 5 presented herein can range from four inches to ten inches (101 mm to 254 mm), or six inches to ten inches (152 mm to 254 mm).

In some embodiments, a flexible, adherent sheet is configured to surround and conform to an outer perimeter of a platform of a platform shoe having a heel located posteriorly of the platform. The sheet comprises an outer layer comprising a durable polymer and an inner layer comprising a pressure-sensitive adhesive. In some embodiments, the durable polymer comprises thermoplastic polyurethane. In some embodiment, the thermoplastic polyurethane is aliphatic thermoplastic polyurethane.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

For purposes of the present disclosure and appended claims, the conjunction “or” is to be construed inclusively (e.g., “an apple or an orange” would be interpreted as “an apple, or an orange, or both”; e.g., “an apple, an orange, or an avocado” would be interpreted as “an apple, or an orange, or an avocado, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives. For purposes of the present disclosure and appended claims, the words “comprising,” “including,” “having,” and variants thereof, wherever they appear, shall be construed as open-ended terminology, with the same meaning as if the phrase “at least” were appended after each instance thereof.

1. A protector comprising:
a flexible, adherent sheet configured to surround and conform to an outer perimeter of a platform of a platform shoe having a heel located posteriorly of the platform, the sheet comprising an outer layer comprising a durable polymer and an inner layer comprising a pressure-sensitive adhesive.

2. The protector of claim 1, wherein the durable polymer comprises thermoplastic polyurethane.

3. The protector of claim 2, wherein the thermoplastic polyurethane comprises aliphatic thermoplastic polyurethane.

4. The protector of claim 1, wherein the outer layer has a thickness of between 0.05 mm and 3.00 mm.

5. (canceled)

6. The protector of claim 1, wherein the durable polymer comprises a film.

7. The protector of claim 6, wherein the film comprises a thermoplastic polyurethane film.

8-11. (canceled)

12. The protector of claim 1, wherein the pressure-sensitive adhesive comprises polyacrylate.

13. (canceled)

14. The protector of claim 1, wherein the sheet has a refractive index of less than 1.65.

15-18. (canceled)

19. The protector of claim 1, wherein the sheet comprises a pre-cut shape.

20. The protector of claim 19, wherein the pre-cut shape has an upper side having a first curvilinear contour having a central convexity.

21. The protector of claim 20, wherein the first curvilinear contour has a first concavity adjacent to the central convexity at a first side.

22. The protector of claim 21, wherein the first curvilinear contour has a second concavity adjacent to the central convexity at a second side, opposite the first side.

23. The protector of claim 22, wherein a centerline of the sheet passes through the upper extreme of the sheet and through a mid-point of the first curvilinear contour.

24. The protector of claim 19, wherein the pre-cut shape has a lower side having a second curvilinear contour having a central concavity.

25-27. (canceled)

28. The protector of claim 24, wherein the pre-cut shape has a first lateral side and a second lateral side defining a first width of the pre-cut shape at an upper portion and defining a second width of the pre-cut shape at a lower portion.

29. The protector of claim 28, wherein the upper portion of the pre-cut shape is wider than the lower portion of the pre-cut shape.

30-39. (canceled)

40. The protector of claim 1, wherein the outer layer provides an outer surface having a gloss finish.

41. The protector of claim 1, wherein the outer layer is configured such that scuffs or abrasions on an outer surface of the outer layer can be significantly reduced by adding heat to the outer layer.

42-43. (canceled)

44. The protector of claim 1, wherein the outer layer comprises an outer sub-layer, and an inner sub-layer, wherein the inner layer is adhered to the inner sub-layer.

45-48. (canceled)

49. The protector of claim 44, wherein the outer layer further comprises a middle sub-layer between the inner sub-layer and the outer sub-layer.

50. The protector of claim 49, wherein the middle sub-layer comprises polyvinyl chloride.

51-60. (canceled)

61. A method for applying a protector onto a platform of a platform shoe, the method comprising:
wrapping a pre-cut sheet having a pre-applied adhesive on a first surface of the sheet around the platform; and
applying internally oriented radial pressure to a second surface of the sheet such that the pre-applied adhesive adheres to an exterior of the platform.

62. The method of claim 61, wherein the adhesive comprises a pressure-sensitive adhesive.

63-66. (canceled)

67. The method of claim 61, wherein the pre-cut sheet is configured to substantially cover an exterior of the platform when the sheet is wrapped closely therearound, with no overlap or minimal overlap.

68-72. (canceled)

73. The protector of claim 1, wherein the pressure-sensitive adhesive is heat activatable.

74. The protector of claim 1, wherein the pressure-sensitive adhesive is configured to adhere to the outer perimeter of the platform.

75. The protector of claim 1, wherein the sheet is configured to wrap around all of a continuous circumferentially extending surface that defines the platform.
